(19) United States
(12) Patent Application Publication
(10) Pub. No.: US 2019/0276476 A1
(43) Pub. Date: Sep. 12, 2019

(54) TWO-DIMENSIONAL METAL-ORGANIC-FRAMEWORKS

(71) Applicants: Bohan Shan, Mesa, AZ (US); Yuxia Shen, Mesa, AZ (US); Sefaattin Tongay, Tempe, AZ (US); Bin Mu, Tempe, AZ (US); Ashutosh Agarwal, Tempe, AZ (US); Ying Qin, Tempe, AZ (US)

(72) Inventors: Bohan Shan, Mesa, AZ (US); Yuxia Shen, Mesa, AZ (US); Sefaattin Tongay, Tempe, AZ (US); Bin Mu, Tempe, AZ (US); Ashutosh Agarwal, Tempe, AZ (US); Ying Qin, Tempe, AZ (US)

(21) Appl. No.: 16/294,558

(22) Filed: Mar. 6, 2019

Related U.S. Application Data
(60) Provisional application No. 62/639,098, filed on Mar. 6, 2018.

(51) Int. Cl. C07F 3/06; C07F 1/08

(52) U.S. Cl. CPC C07F 3/06; C07F 1/08

(57) ABSTRACT

Synthesizing a metal-organic-framework includes combining a first solution and a second solution to yield a synthetic medium. The first solution typically includes a solvent, an inhibitor, a metal capping agent, a ligand, and a metal source, and the second solution typically includes a deprotonating agent and a buffer. The metal and the ligand are reacted in the synthetic medium to yield a two-dimensional metal-organic-framework in the form of a nanosheet, and the two-dimensional metal-organic-framework is removed from the synthetic medium. The two-dimensional metal-organic framework has an aspect ratio of at least 300 or at least 1000.

This application claims the benefit of U.S. Application No. 62/639,098 entitled “TWO-DIMENSIONAL METAL-ORGANIC-FRAMEWORKS” and filed on Mar. 6, 2018, which is incorporated herein by reference in its entirety.

### TECHNICAL FIELD

This invention relates to synthesis of two-dimensional (2D) metal-organic-frameworks (MOF).

### BACKGROUND

Metal-organic-framework (MOFs) are materials constructed by joining inorganic metal-containing units with organic linkers, bonded strongly to create open crystalline frameworks with enduring porosity. Two-dimensional (2D) MOF nanosheets are based on “top-down” exfoliation (e.g., sonication and ball milling) of bulk MOFs. However, owing to the strong destructive mechanical force, these resultant products are prone to degrade into fragments with very limited lateral size and wide distribution of thickness.

### SUMMARY

One of the challenges in the manufacturing of two-dimensional (2D) metal-organic-frameworks (MOFs) is the hydrogen bonds between adjacent layers. As described herein, 2D MOFs are synthesized by a process in which dimensional growth and hydrogen bonding between layers are controlled. The resulting 2D MOFs may have a thickness of one unit cell (monolayer) or more (bilayer and greater). Large areas of ultrathin MOFs can be deposited onto suitable metallic, semiconducting, and insulating substrates, such as SiO₂, GaAs, sapphire, and mica.

In a first general aspect, synthesizing a metal-organic-framework includes combining a first solution and a second solution to yield a synthetic medium. The first solution includes a solvent, an inhibitor, a metal capping agent, a ligand, and a metal source comprising a metal. The second solution includes a deprotonating agent and a buffer. The metal and the ligand in the synthetic medium are reacted to yield a two-dimensional metal-organic-framework in the form of a nanosheet, and the two-dimensional metal-organic-framework is removed from the synthetic medium.

Implementations of the first general aspect can include one or more of the following features.

Combining the first solution and the second solution may include providing the first solution beneath the second solution (e.g., injecting the first solution beneath the second solution). The solvent may include N,N-diethylformamide. The solvent is anhydrous or free of added water. The solvent may be free of added N,N-dimethylformamide. The inhibitor may include formic acid. The metal capping agent may include pyridine. The ligand may include terephthalic acid. The metal source may include zinc nitrate, copper nitrate, or both. In some cases, the metal source is free of acetate. The deprotonating agent may include triethylamine. The buffer may include hexane. The first and second solution are typically immiscible. The two-dimensional metal-organic-framework may include zinc benzenedicarboxylate or copper benzenedicarboxylate. In some cases, the two-dimensional metal-organic-framework is disposed on a substrate. The two-dimensional metal-organic-framework may be exfoliated.

A second general aspect includes the metal-organic-framework of the first general aspect. The metal-organic framework may have an aspect ratio of at least 200 or at least 1000. The metal-organic-framework may be in the form of a monolayer or a bilayer.

Bi-phase synthesis described herein allows control over formation of hydrogen bonds as well as in-plane growth using a monodentate organic base as a capping agent for the metal to reduce interlayer interaction in the formation of 2D MOFs, thereby promoting layered formation and separation into monolayers. A monodentate organic acid can be used as an inhibitor and deprotonating agent, the combined effects of which increase the aspect ratio of the resulting crystals. Unlike traditional three-dimensional (3D) MOFs, 2D MOFs synthesized as described herein can be exfoliated easily by mechanical methods (e.g., contact with adhesive tape). These 2D MOFs are suitable for use as separation membranes and for use in gas absorption, catalysis, sensors, and the like.

### BRIEF DESCRIPTION OF THE DRAWINGS

FIG. 1 depicts a two-dimensional (2D) layer of zinc benzenedicarboxylate (Zn-BDC or 2D MOF-2).

FIG. 2 depicts bi-phase synthesis of 2D MOF-2.

FIG. 3A shows powder X-ray diffraction patterns of 2D MOF-2 and traditional MOF-2 (Tra-MOF-2). FIG. 3B shows a powder X-ray diffraction pattern of MOF-2.

FIG. 4A shows Raman spectra of pyridine, N,N-diethylformamide (DEF), terephthalic acid (H₂BDC), and 2DMOF-2 synthesized as described herein. FIG. 4B shows Raman spectra of N,N-dimethylformamide (DMF), Tra-MOF-2, DEF, and 2DMOF-2.

FIG. 5A depicts a secondary building unit (SBU) of 2D MOF-2. FIG. 5B depicts Raman modes P1-P5.

FIG. 6 shows Raman spectra of DEF, CuBDC, and 2D MOF-2.

### DETAILED DESCRIPTION

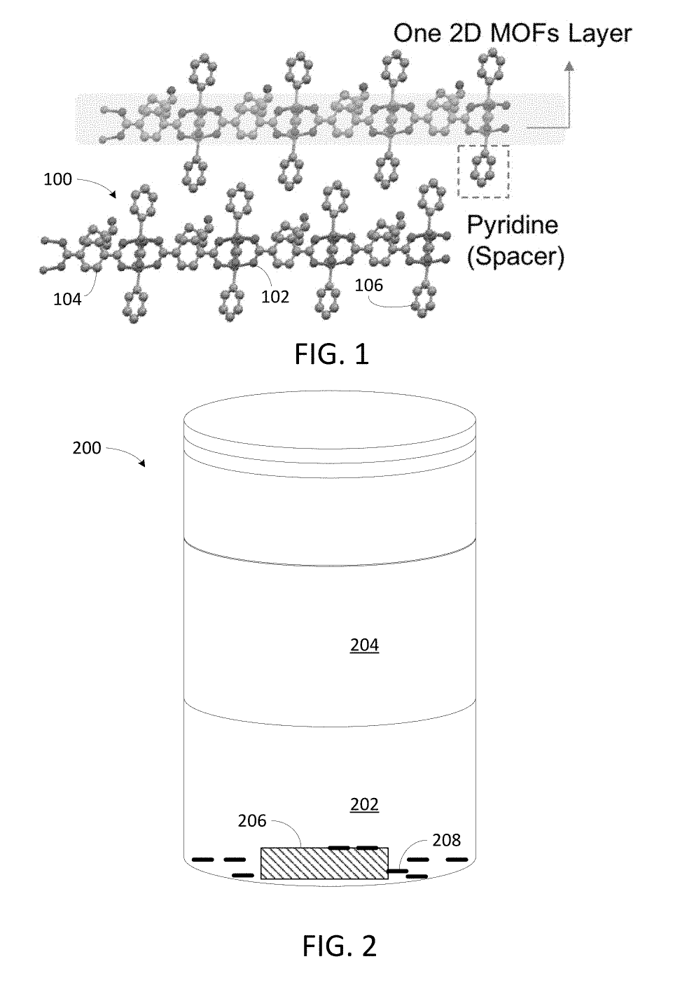

Metal-organic-frameworks (MOFs) are inorganic-organic hybrid solids with infinite repeating structures, or frameworks, built from metal cations or clusters connected by organic linkers. Metal-centered secondary building units (SBUs) are commonly used to classify MOF structures. In one example, deprotonated terephthalic acid coordinates with Zn clusters to form coordination bonds by sharing the electrons with an empty Zn orbital. FIG. 1 depicts two-dimensional (2D) MOF layer 100 of zinc benzenedicarboxylate (Zn-BDC or MOF-2) formed from Zn clusters 102 and terephthalic acid 104. Pyridine spacers 106 are bonded to Zn clusters 102.

Dimension control in the synthesis of 2D MOFs is described herein with respect to 2D MOF-2 (Zn-BDC). “2D MOF” generally refers to a MOF in which the unit cell of the MOF typically expands only in a 2D planar manner. However, these techniques may be applied to the synthesis of other 2D MOFs, such including Cu-BDC and others. The synthesis process includes a bi-phase growth process, in which a first solution is provided beneath a second solution. Providing the first solution beneath the second solution can include slow injection of the first solution beneath the second solution (e.g., with a pipette), or other appropriate method in which the interface between the first solution and the second solution is minimally disturbed. The first solution is typically more dense than the second solution, and the first solution and the second solution are typically immiscible. A 2D MOF is synthesized on a substrate in the first solution.

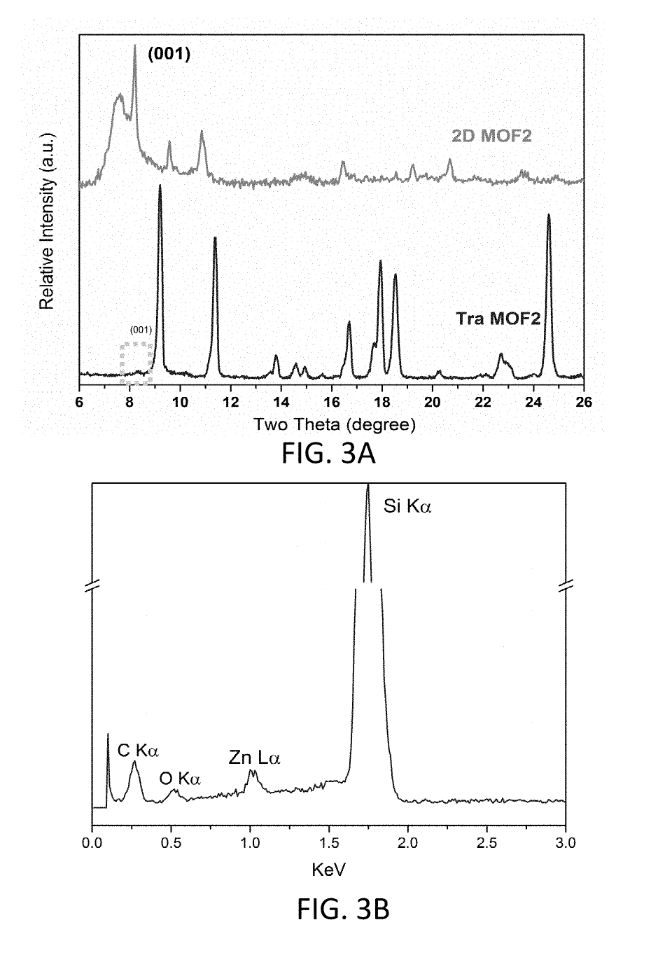

FIG. 2 depicts reaction vessel 200 including first solution 202, second solution 204, optional substrate 206, and MOF 208. Interface 210 is present between first solution 202 and second solution 204. The first solution (or “lower phase”) can include a solvent, an inhibitor, a metal source, a metal capping agent, and a ligand. First solution 202 is nonaqueous and may be anhydrous or free of added water, thereby reducing hydrogen bonding (metal-water interaction) between resulting MOF layers. In some examples, the metal source includes zinc or copper. The solvent is typically polar. In some examples, the solvent is N,N-diethylformamide (DEF). Formic acid may be used as an inhibitor to reduce the reaction rate, thereby improving crystallinity of the resulting 2D MOF. The metal source may provide zinc or copper ions. Pyridine may be used as a metal capping agent, to “cap” Zn before water that may be present interacts with the Zn. Terephthalic acid may be used as the ligand.

Second solution 204 (or the “upper phase”) typically includes a buffer and a deprotonating agent. The deprotonating agent is typically able to react with protons and is typically miscible with the buffer. The buffer is typically immiscible with the solvent in first solution 202. The buffer can be an organic solvent, such as hexane. The deprotonating, agent is selected to control injection of first solution 202. In some cases, the deprotonating agent can remove protons that accumulate in solution, thereby reducing the rate of MOF formation. In one example, the deprotonating agent is triethylamine (TEA). TEA is provided in second solution 204, but is typically soluble in first solution 202. Thus, a concentration gradient of TEA may form in first solution 202. The formic acid and gradient TEA in first solution 202 provide effective control over proton concentration as well as the quantity of partially deprotonated ligand.

To synthesize MOF 208, first solution 202 is provided under second solution 204 in such a way as to reduce or minimize impact on interface 210 between the first solution and the second solution, thereby reducing or minimizing transport of TEA from the second solution to the first solution. The combined solutions are maintained at room temperature (e.g., for a day) to allow sufficient growth of the MOF. MOF 208 may grow on a wall of reaction vessel 200, optional substrate 206, or both. During hi-phase MOF synthesis, the interlayer stacking rate is governed at least in part by hydrogen bonds formed between MOF layers. The intralayer (in-plane) growth rate is governed at least in part by the reaction rate between the metal and the ligand (e.g., Zn and terephthalic acid). Increasing the rate of intralayer growth relative to interlayer growth can be achieved by reducing the formation of hydrogen bonds, weakening the bond strength of any hydrogen bonds formed, or both. Weakening the bond strength of hydrogen bonds formed allows isolation of monolayer thick MOFs. Growth rate and crystallinity may be controlled by the presence of an inhibitor (e.g., formic acid), a deprotonating agent (e.g., TEA), or both. Overall yields are at least 70% for 2D MOF-2 and at least 80% for Cu-BDC.

During the hi-phase synthesis process, oxygen atoms in water molecules attach to metal clusters (e.g., Zn clusters) through coordination interaction. To reduce or eliminate this interaction, solvents are nonaqueous (e.g., anhydrous or free of added water). A solvent containing water has been shown to result in 3D MOFs. Hydrogen bonds are understood to form among water-DMF via O—H_{w}—O_{DMF} interaction. To reduce this interaction, DEF is used (e.g., rather than N,N-dimethylformamide (DMF)) as the solvent. The larger alkyl substitution on formamide is understood to decrease the corresponding hydrogen bond strength. The pore size of MOF-2 is around 5 Å. The kinetic diameter of DMF is around 5.5 Å. Thus, there may be some molecular realignment in the pores. When the solvent is replaced by N,N-diethylformamide (DEF), the presence of solvent molecules in the pores is reduced.

A metal capping agent, such as pyridine, can be used to inhibit any water molecules present from coordinating with the metal clusters. Adding pyridine to first solution 202 limits layer by layer growth so that thickness control can be achieved. Unlike triethylamine, the N atom in pyridine is exposed to the surface. The electron can be donated to the Zn cluster in a similar way as the oxygen atom in water molecule. The pKa value of pyridine conjugate acid is around 5.25. The pKa value of water conjugate acid is around −1.74 (hydronium). As such, the Zn-pyridine interaction is stronger than Zn-water interaction. Therefore, the presence of the metal capping agent can reduce the number of hydrogen bonds.

A high aspect ratio (ratio of dimensions in the 2D plane of the MOF) can be promoted by having a small number of nuclei, and allowing the nuclei to grow larger in size. In MOF synthesis, reaction occurs between Zn clusters and deprotonated terephthalic acid. As the reaction progress, the protons from terephthalic acid accumulate in the synthesis solution. Eventually, the protons can terminate the crystal growth with the partially deprotonated ligands acting as surfactants. TEA can be used as a deprotonating agent in the second solution by mixing with unreactive hexane solvent. The TEA removes protons accumulated in the solution, thereby increasing the reaction rate. The TEA may be combined with the hexane and slowly diffuse into the first solution (containing the metal and the ligand) controllably (depending on the concentration, etc.). As described previously, the second solution may contain other components, such as zinc nitrate, terephthalic acid, formic acid, and pyridine. It is not believed that TEA impacts the morphology of the resulting MOE This may be attributed to the configuration of TEA, in which the proton acceptor is encapsulated close to the center.

The added. TEA can coordinate with the protons generated in the synthesis. Directly mixing TEA with reactants may increase the reaction rate, potentially lowering the resulting crystallinity. Hexane may serve as a buffer to limit the increase in reaction rate by allowing the TEA to diffuse slowly into the lower phase to remove the accumulated protons without over-accelerating the reaction.

In some cases, the lower phase includes an inhibitor, such as formic acid, to slow down the reaction. The pKa value of formic acid is around 3.75, which is close to the first pKa value of terephthalic acid (3.5 and 4.4). Formic acid inhibits the ligand from deprotonation and reduces the nucleation rate (the concentration of formic acid exceeds that of terephthalic acid). Without the addition of TEA, the added formic acid may inhibit formation of solid product. Therefore, this bi-phase method allows a smaller number of nuclei formed at an initial stage and longer crystal growth, yielding a MOF with a higher aspect ratio. In summary, while protons from terephthalic acid can halt the chemical reaction, the protons can be removed by TEA. Although adding TEA directly can accelerate the reaction, the presence of formic acid can slow down the reaction, resulting in better crystallization.

The hi-phase process described with respect to FIG. 2 yields highly lamellar van der Waals (vd.W) MOF sheets (e.g., Zn-BDC, Cu-BDC, or others) with a capacity for scalable synthesis of 2D MOFs without sacrificing crystallinity. The layers of the 2D vdw MOFs are bonded weakly via vdW forces; thus MOFs of a few layers or even a single layer (monolayer) can be obtained by exfoliating 2D MOFs onto a substrate (e.g., SiO₂/Si, Si (111), mica, sapphire, and indium tin oxide (ITO) glass) or in the absence of a substrate, without sacrificing the lateral dimension. A typical aspect ratio exceeds 1000.

When the metal source includes Zn(OAc)₂, the change caused by acetate establishes a coordination equilibrium different from that in the absence of acetate (e.g., when the metal source is Zn(NO₃)₂). Unlike formic acid, the pKa value of acetic acid (4.75) is close to the second pKa value of terephthalic acid. Therefore, the Zn-ligand interaction is compatible with Zn-acetate interaction. Acetic acid, a monodentate ligand, can coordinate with Zn cluster at any position that a ligand can occupy, thereby inhibiting growth in some directions. As such, the presence of acetic acid can slow growth of the MOF in sonic directions.

In the bi-phase synthesis, MOF 208 grows on substrate 206 as well as vessel 200 containing the solutions. Meanwhile, wetting of substrate 206 by the solvent can impact the rate of nucleation on the substrate. In particular, a Piranha treatment may improve crystal formation on a SiO₂ substrate. This may be attributed to the —OH groups formed at the surface.

Table 1 lists components of solutions used to synthesize MOF-2 via the bi-phase process disclosed herein (2D MOF-2), as well as MOF-2 synthesized by a diffusion process and a mixing process (Tra MOF-2). The diffusion process is described in Rodenas et al. Metal-organic framework nanosheets in polymer composite materials for gas separation. Nature Materials 14, 48-55 (2015). Growth conditions and crystal features of these methods are compared in Table 1.

TABLE 1
MOFs synthesized by various methods

| | Bi-phase | Diffusion | Mixing |
|---|---|---|---|
| Component | Process | Process | Process |
| Ligand | H₂BDC | H₂BDC | H₂BDC |
| Metal source | Zn(NO₃)₂ | Zn(NO₃)₂ | Zn(NO₃)₂ |
| Solution | DEF | | |
| Capping agent | Pyridine | | |
| Buffer agent | Hexane | | |
| Modulator | Formic acid | | |
| Deprotonating | Triethylamine | | |
| agent | (TEA) | | |
| Growth | Growth speed in | Growth speed | Growth speed |
| features | three-dimensional | is manipulated | is excessive. |
| | directions are | by diffusion | |
| | controlled finely. | rates. | |
| Crystal | a) Flakes can be | a) 3D chunk | a) 3D bulk |
| features | exfoliated into a | crystal | crystal |
| | monolayer | b) Very low | |
| | b) Large aspect | yield | |
| | ratio | | |
| | c) High yield | | |

In one example, a 2D MOF-2 nanosheet formed by the bi-phase process described herein on GaAs has a lateral size of 17.13 μm and an aspect ratio of 342. A monolayer MOF-2 nanosheet formed by the bi-phase process described herein on SiO₂/Si has a lateral size of 25.66 μm and an aspect ratio greater than 1000. Atomic force microscopy of a 2D MOF-2 nanosheet formed by the bi-phase process described herein on SiO₂/Si revealed first, second, and third layers having a thickness of 2.3 nm, 1.3 nm, and 1.2 nm, respectively. The measured thickness of 1.2 nm (layer 3) is consistent with theoretical estimates. Comparative MOF-2 samples formed by diffusion and mixing processes, referred to in Table 1, yielded chunk or bulk crystals, but no 2D MOF-2.

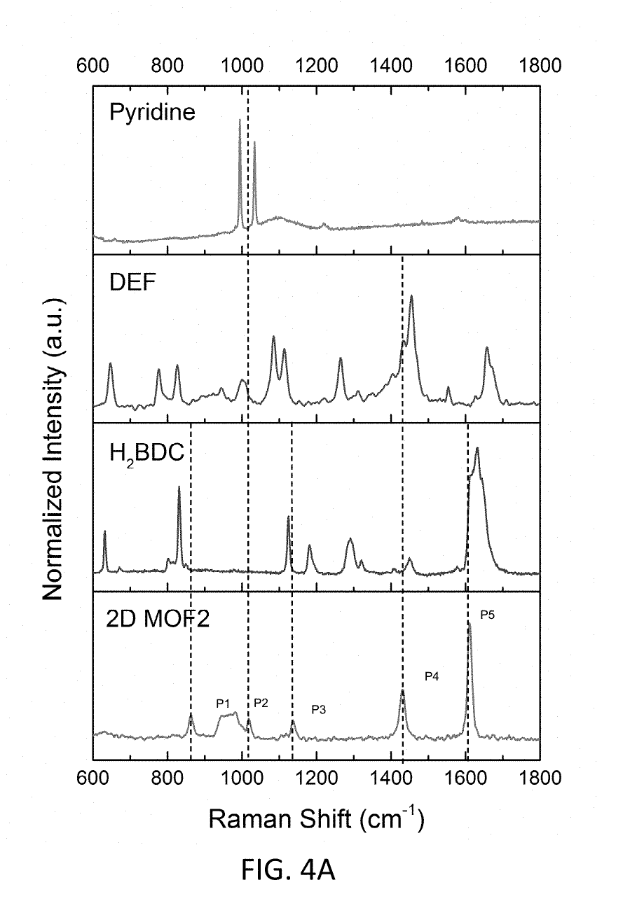

FIG. 3A shows powder X-ray diffraction (XRD) patterns of 2D MOF-2, synthesized by a bi-phase process as described herein, and TRA MOF-2, synthesized by a traditional mixing process described with respect to Table 1. 2D MOF-2 has a predominant (001) peak at 8.1°, according to the Bragg equation (2dₕₖₗ sin θₕₖₗ=nλ, λ=1.5406 Å). The interplanar distance of 2D MOF-2 is 1.08 nm, comparable to intentionally intercalated MOF-2. In contrast, the (001) peak is weak in traditional MOF-2 and the interplanar distance is slightly reduced 2θ=8.3°. This reduction is understood to be related to random orientation of the crystals. FIG. 3B shows a powder X-ray diffraction pattern of MOF-2 for comparison.

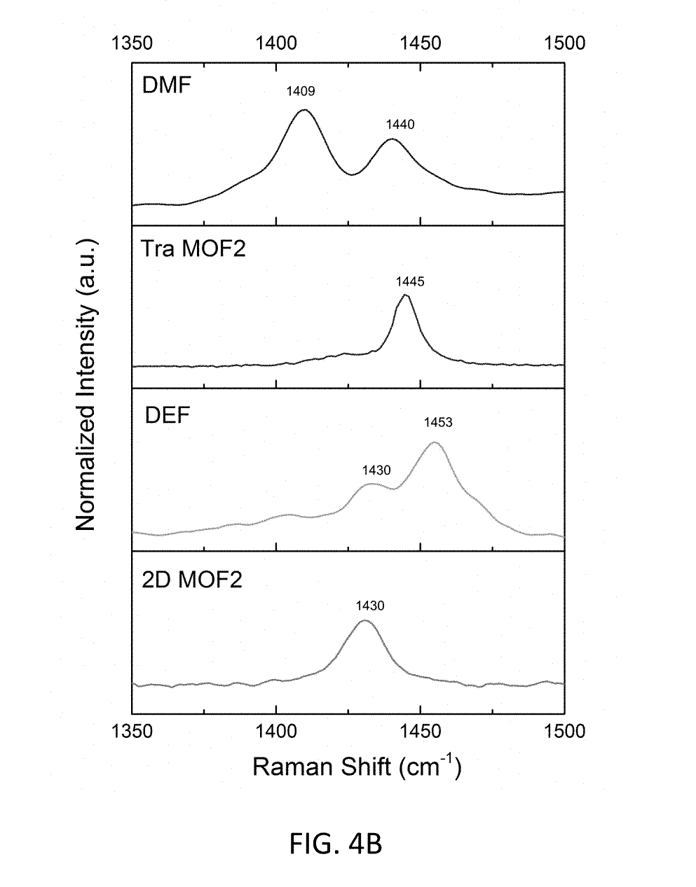

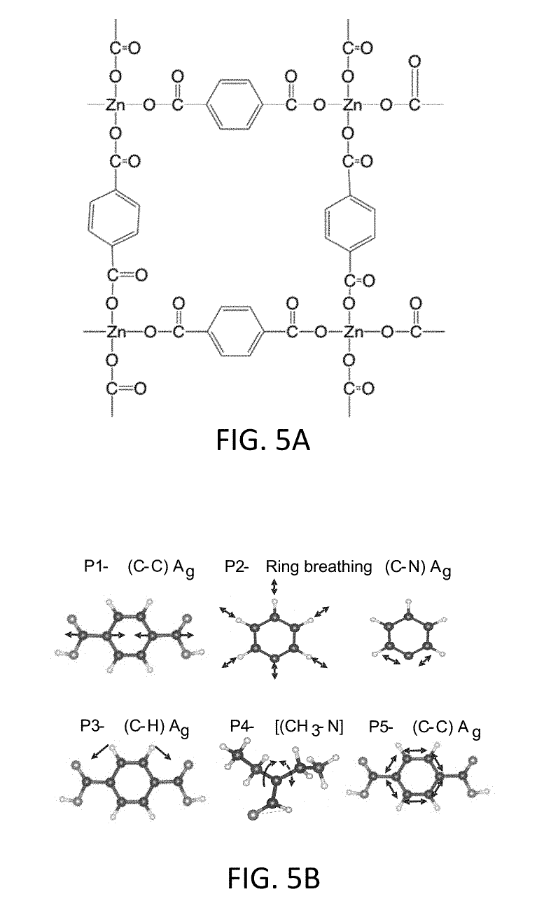

FIG. 4A shows Raman spectra of pyridine, N,N-diethylformamide (DEF), terephthalic acid (H₂BDC), and 2D MOF-2 synthesized as described herein. FIG. 4B shows Raman spectra of N,N-dimethylformamide (DMF), Tra-MOF-2, DEF, and 2D MOF-2. FIG. 5A depicts a secondary building unit (SBU) of 2D MOF-2. FIG. 5B depicts Raman modes P1-P5. Table 2 shows positions, related peak positions, and assignments of Raman modes P1-P5 in the spectra of FIGS. 4A and 4B.

TABLE 2
Raman Peaks of 2D MOF-2 and MOF-2

| Peak | Position | Related Peak | |
|---|---|---|---|
| No. | (cm⁻¹) | Position (cm⁻¹) | Assignment |
| P1 | 861 | H₂BDC - 831 | (C—C) A_{g} |
| P2 | 1018 | Pyridine - 995 and/or 1034 | Ring breathing; |
| | | | (C—N) A_{g} |
| P3 | 1135 | H₂BDC - 1126 | (C—H)_A_{g} |
| P4 | 1430 | DEF - 1430 and/or 1455 | ₛ[(CH₅—N]; |
| | | | ₐₛ[(CH₅—N) |
| P5 | 1611 | H₂BDC - 1609 | (C—C) Ag |

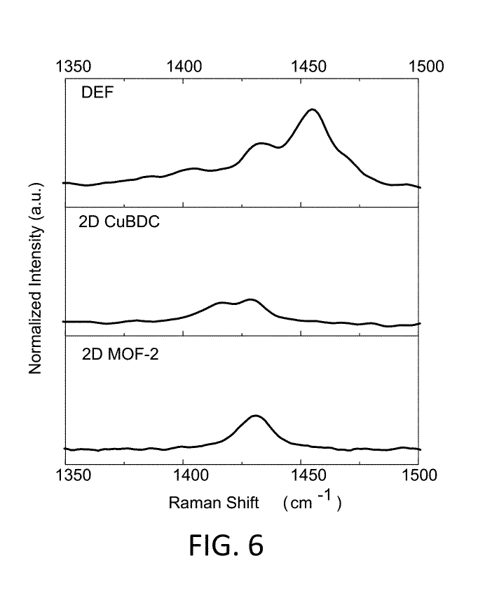

Copper 1,4-benzenedicarboxylate MOF (2D Cu-BDC) was grown as described with respect to FIG. 2. FIG. 6 shows Raman spectra of DEF, 2D Cu-BDC, and 2D MOF-2. Intermediate morphology of 2D Cu-BDC indicates that the MOF is a result of intergrowth of adjacent crystals. A supply of reactants is provided by the consecutive TEA gradient.

A number of embodiments have been described. Nevertheless, it will be understood that various modifications may be made without departing from the spirit and scope of disclosure. Accordingly, other embodiments are within the scope of the following claims.

What is claimed is:

1. A method of synthesizing a metal-organic-framework, the method comprising:
combining a first solution and a second solution to yield a synthetic medium, wherein:
the first solution comprises a solvent, an inhibitor, a metal capping agent, a ligand, and a metal source comprising a metal, and
the second solution comprises a deprotonating agent and a buffer;
reacting the metal and the ligand in the synthetic medium to yield a two-dimensional metal-organic-framework in the form of a nanosheet; and
removing the two-dimensional metal-organic-framework from the synthetic medium.

2. The method of claim 1, wherein the solvent comprises N,N-diethylformamide.

3. The method of claim 1, wherein the solvent is free of added water.

4. The method of claim 1, wherein the solvent is free of added N,N-dimethylformamide.

5. The method of claim 1, wherein the inhibitor comprises formic acid.

6. The method of claim 1, wherein the metal capping agent comprises pyridine.

7. The method of claim 1, wherein the ligand comprises terephthalic acid.

8. The method of claim 1, wherein the metal source comprises zinc nitrate, copper nitrate, or both.

9. The method of claim 1, wherein the metal source is free of acetate.

10. The method of claim 1, wherein the deprotonating agent comprises triethylamine.

11. The method of claim 1, wherein the buffer comprises hexane.

12. The method of claim 1, wherein the first solution and the second solution are not miscible.

13. The method of claim 1, wherein two-dimensional metal-organic-framework comprises zinc benzenedicarboxylate or copper benzenedicarboxylate.

14. The method of claim 1, further comprising disposing the two-dimensional metal-organic-framework on a substrate.

15. The method of claim 1, further comprising exfoliating the two-dimensional metal-organic-framework.

16. The method of claim 1, wherein combining the first solution and the second solution comprises providing the first solution beneath the second solution.

17. The two-dimensional metal-organic-framework of claim 1.

18. The two-dimensional metal-organic-framework of claim 17, wherein an aspect ratio of the two-dimensional metal-organic-framework is at least 300.

19. The two-dimensional metal-organic framework of claim 17, wherein the aspect ratio of the two-dimensional metal-organic-framework is at least 1000.

20. The two-dimensional metal-organic-framework of claim 17, wherein the two-dimensional metal-organic-framework is in the form of a monolayer or a bilayer.
